(19) United States
(12) Patent Application Publication
(10) Pub. No.: US 2006/0077109 A1
(43) Pub. Date: Apr. 13, 2006

(54) Heating line pattern structure of defogger

(75) Inventors: Yuji Baba, Tokyo (JP); Tatsumi Tokuda, Tokyo (JP)

Correspondence Address: RATNERPRESTIA, P O BOX 980, VALLEY FORGE, PA, 19482-0980, US

(73) Assignee: Nippon Sheet Glass Company, Limited, Tokyo (JP)

(21) Appl. No.: 11/240,983

(22) Filed: Sep. 30, 2005

(30) Foreign Application Priority Data
Sep. 30, 2004 (JP) 2004-287198

(51) Int. Cl. H01Q 1/02

(52) U.S. Cl. 343/704

(57) ABSTRACT

A structure of a heating line pattern of a defogger for improving the directivity of an FM antenna in an antenna for a motor vehicle comprising AM and FM antennas formed on a rear window glass panel. A heating line pattern structure comprises two bus-bars formed on both sides of the rear window glass panel, a plurality of heating lines arranged in parallel in a horizontal direction between the two bus-bars, and first and second linear conductors formed in a line in a vertical direction at the central portion of the defogger.

### BACKGROUND OF THE INVENTION

1. Field of the Invention

The present invention relates to a heating line pattern structure of a defogger formed on a window glass panel of a motor vehicle, particularly to a heating line pattern structure of a defogger formed on a window glass panel on which an AM antenna and FM antenna are provided. The present invention further relates to an antenna for a motor vehicle comprising such defogger.

2. Related Art

In Japanese Patent Publication No. P2003-500870A, there is disclosed an example of an antenna for a motor vehicle comprising an AM antenna and FM antenna formed on a rear window glass panel on which a defogger for defogging is provided. FIG. 1 shows the antenna disclosed in the publication.

In this antenna, an AM antenna 14 is formed on a space of a rear window glass panel 12 between a defogger 10 and an edge of a vehicle body, and an FM antenna 16 is formed on a space of the rear window glass panel 12 between the defogger 10 and the AM antenna 14.

The AM antenna 14 is composed of a plurality of linear conductors 14a arranged in a horizontal direction like a fork shape. The sensitivity of the AM antenna 14 is determined by the area of an antenna pattern thereof, so that the AM antenna 14 is provided in such a manner that the antenna pattern occupies the most part of a space above the defogger 10 on the rear window glass panel 12.

The FM antenna 16 is formed by one linear conductor extending in a horizontal direction on a space between the AM antenna 14 and the defogger 10.

A feeding terminal 14b of the AM antenna 14 is connected to an AM amplifier 20 through a lead wire, and a feeding terminal 16a of the FM antenna 16 is connected to an FM amplifier 22 through a lead wire. The outputs of respective amplifiers are connected to a receiver 24 through a coaxial cable.

The defogger 10 comprises bus-bars 10a and 10b arranged oppositely in an up and down direction on both sides of the rear window glass panel 12, and a plurality of heating lines 10c arranged in a horizontal direction between the bus-bars 10a and 10b. A direct-current (DC) power supply 26 is connected between the feeding terminals 10d and 10e.

The FM antenna 16 is capacitively coupled to the heating lines of the defogger 10, so that the heating lines may be utilized as an auxiliary FM antenna.

In this case, if a linear conductor extending in a vertical direction is provided to connect the heating lines together at the central portion of the defogger, then the linear conductor controls the capacitive coupling in a high frequency between the FM antenna and heating lines, resulting in the improvement of the sensitivity of the FM antenna. In FIG. 9 of the publication, there is disclosed an example in which one linear conductor is provided in a vertical direction at the central portion of the defogger. However, it has been understood for those skilled in the art that a good directivity could not be realized by only one linear conductor.

The object of the present invention is to provide a structure of a heating line pattern of a defogger for improving the directivity of an FM antenna in an antenna for a motor vehicle comprising AM and FM antennas formed on a rear window glass panel on which the defogger is provided.

Another object of the present invention is to provide an antenna for a motor vehicle comprising such defogger.

### SUMMARY OF THE INVENTION

A first aspect of the present invention is a structure of a heating line pattern of a defogger formed on a rear window glass panel on which AM and FM antennas are provided, the FM antenna being arranged between the AM antenna and the defogger. The structure comprises two bus-bars formed on both sides of the rear window glass panel, a plurality of heating lines arranged in parallel in a horizontal direction between the two bus-bars, and first and second linear conductors formed in a line in a vertical direction at the central portion of the defogger.

The first linear conductor extends downward from the topmost heating line of the plurality of heating lines, the second linear conductor extends upward from the bottommost heating line of the plurality of heating lines, and the first and second linear conductors are separated across at least one heating line interval, one heating line interval being the distance between adjacent heating lines.

It is preferable that the first linear conductor is longer than the second linear line, because the sensitivity is decreased if the first conductor line is shorter than the second linear line.

It is also preferable that a T-shaped conductor composed of a vertical linear conductor and horizontal conductor is formed under the defogger, the vertical linear conductor being connected to the bottommost heating line of the plurality of heating lines.

It is also preferable that a bent conductor is formed under the defogger, the bent conductor being connected to one of the two bus-bars.

A second aspect of the present invention is an antenna for a motor vehicle. The antenna comprises an AM antenna formed on a rear window glass panel of the motor vehicle, an FM antenna formed on the rear window glass panel, and a defogger according to the present invention, the FM antenna being arranged between the AM antenna and the defogger.

### BRIEF DESCRIPTION OF THE DRAWINGS

FIG. 1 shows a conventional antenna for a motor vehicle.

FIG. 2 shows an embodiment 1 according to the present invention.

FIG. 3 shows measured sensitivities in the embodiment 1.

FIG. 4 shows measured directivities in the embodiment 1.

FIG. 5 shows an embodiment 2 according to the present invention.

FIG. 6 shows measured sensitivities in the embodiment 2.

FIG. 7 shows measured directivities in the embodiment 2.

FIG. 8 shows an embodiment 3 according to the present invention.

FIG. 9 shows measured sensitivities in the embodiment 3.

FIG. 10 shows measured directivities in the embodiment 3.

FIG. 11 shows an embodiment 4 according to the present invention.

FIG. 12 shows measured sensitivities in the embodiment 4.

FIG. 13 shows measured directivities in the embodiment 4.

FIG. 14 shows a comparison example 1.

FIG. 15 shows measured sensitivities in the comparison example 1.

FIG. 16 shows measured directivities in the comparison example 1.

FIG. 17 shows a comparison example 2.

FIG. 18 shows measured sensitivities in the comparison example 2.

FIG. 19 shows measured directivities in the comparison example 2.

### BEST MODE FOR CARRYING OUT THE INVENTION

The inventors of the present application have designed defoggers having various heating line patterns and have measured the characteristics thereof in an anechoic chamber to decide the effective structure of a heating line pattern.

### EMBODIMENT 1

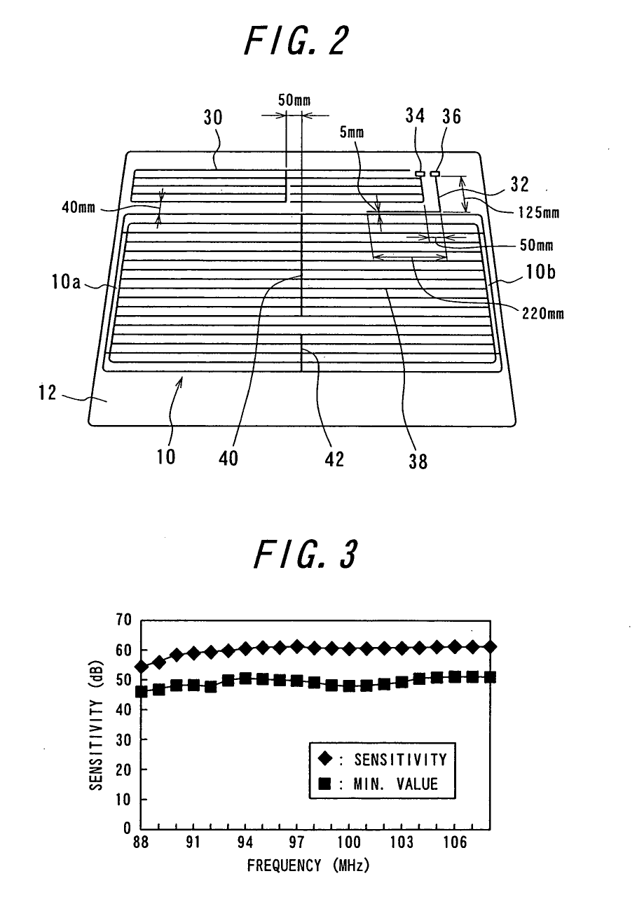

A defogger 10, AM antenna 30, FM antenna 32 are formed on a rear window glass panel 12 of a motor vehicle as shown in FIG. 2.

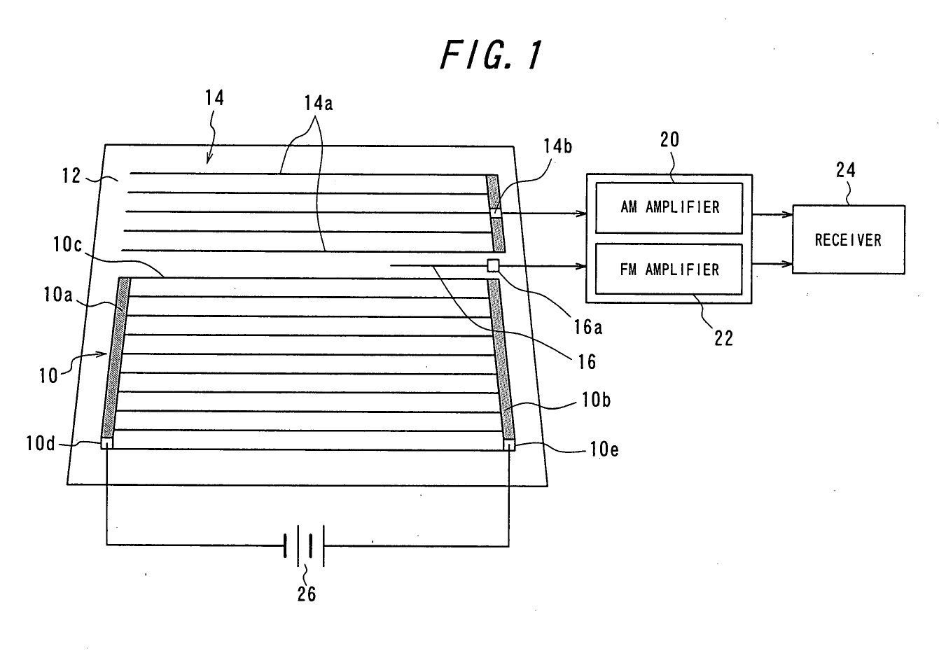

Different from the AM antenna 14 in FIG. 1, the AM antenna 30 has an antenna pattern such that a plurality of horizontal linear conductors (five conductors in this embodiment) are arranged at 25 mm pitch in two regions partitioned by three vertical linear conductors, respectively, and the ends of four horizontal linear conductors in the right region are opened without being connected to the vertical linear conductor as shown in the figure. An FM antenna 32 is structured by one bent conductor different from the FM antenna 16 structured by a linear conductor in FIG. 1. In the figure, reference numeral 34 designates an AM feeding terminal and 36 an FM feeding terminal.

A heating line pattern of a defogger is formed by a plurality of heating lines 38 (18 lines in the present embodiment) arranged in parallel at 30 mm pitch between bus-bars 10a and 10b, and two linear conductors 40 and 42 arranged in a vertical direction in such a manner that they are positioned in a line at the central portion of the defogger 10.

Assuming that a distance between adjacent heating lines is one heating line interval, the vertical linear conductor 40 extends downward across 11 intervals from the topmost heating line. The vertical linear conductor 42 extends upward across 4 intervals from the bottommost heating line. Each of the vertical linear conductors 40 and 42 is electrically connected to the crossed heating lines 38.

The vertical linear conductors 40 and 42 are separated across 2 heating line intervals in a vertical direction.

A motor vehicle comprising a rear window glass panel provided with the defogger including the AM and FM antennas as described above is set in an anechoic chamber and rotated around 360° to measure a sensitivity (a maximum value, average value and minimum value) and directivity thereof.

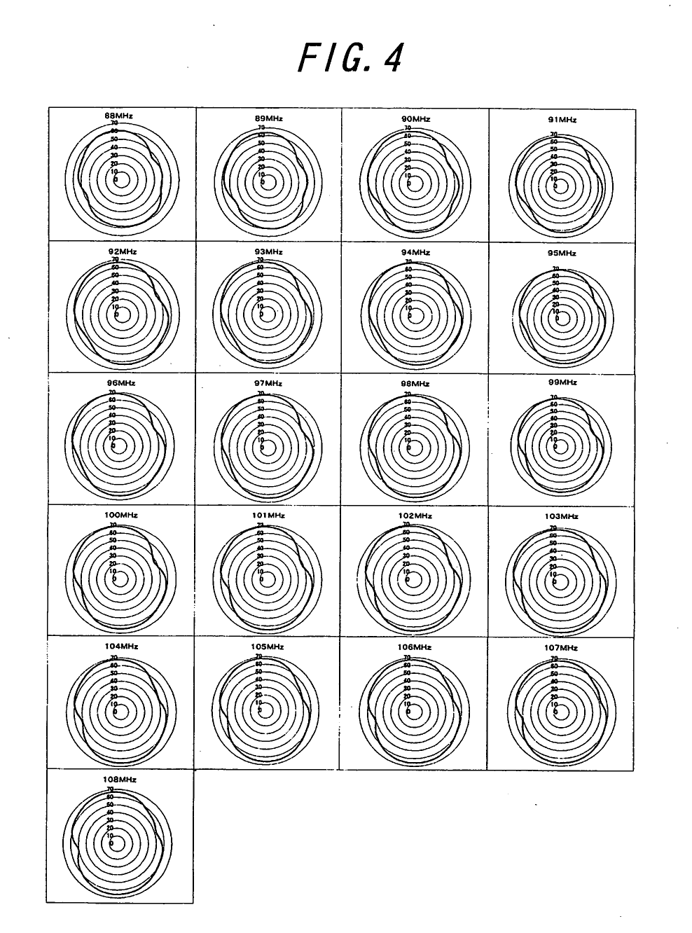

A sensitivity, i.e., a dipole (=60 dB) ratio sensitivity is measured every 1 MHz in the FM band of 88-108 MHz to determine a maximum value, average value and minimum value thereof. The measured sensitivities are shown in Table 1. FIG. 3 shows the graph illustrating the minimum values of the measured sensitivities. FIG. 4 shows the measured directivities in the range of 88-108 MHz. Upward direction in the figure designates the forward direction of a motor vehicle.

TABLE 1

Sensitivity (dB)

| f (MHz) | max. | ave. | min. | max. − min. |
|---|---|---|---|---|
| 88 | 61.4 | 54.6 | 46.0 | 15.4 |
| 89 | 64.3 | 56.2 | 46.8 | 17.5 |
| 90 | 66.5 | 58.5 | 48.4 | 18.1 |
| 91 | 67.2 | 59.3 | 48.2 | 19.0 |
| 92 | 67.2 | 59.4 | 47.5 | 19.7 |
| 93 | 67.9 | 59.8 | 49.5 | 18.4 |
| 94 | 69.0 | 60.6 | 50.4 | 18.6 |
| 95 | 69.3 | 61.0 | 50.2 | 19.1 |
| 96 | 69.1 | 60.9 | 49.8 | 19.3 |
| 97 | 69.0 | 60.8 | 49.5 | 19.5 |
| 98 | 68.9 | 60.7 | 48.7 | 20.2 |
| 99 | 68.7 | 60.4 | 48.0 | 20.7 |
| 100 | 68.8 | 60.4 | 47.9 | 20.9 |
| 101 | 68.8 | 60.6 | 48.1 | 20.7 |
| 102 | 68.6 | 60.6 | 48.6 | 20.0 |
| 103 | 68.3 | 60.7 | 49.4 | 18.9 |
| 104 | 68.1 | 60.9 | 50.3 | 17.8 |
| 105 | 68.0 | 61.0 | 50.7 | 17.3 |
| 106 | 67.6 | 61.0 | 50.7 | 16.9 |
| 107 | 67.3 | 61.0 | 50.7 | 16.6 |
| 108 | 66.9 | 60.8 | 50.2 | 16.7 |
| max. | | | | 20.9 |
| ave. | | 60.0 | | |
| min. | | 54.6 | 46.0 | |

| | |
|---|---|
| ave. sensitivity min. | 54.6 |
| directivity min. | 46.0 |
| directivity (max. − min.) max. | 20.9 |

While the criteria for a required sensitivity and directivity in an entire azimuth are different depending on a kind of motor vehicle, it is assumed as an example that the minimum value of average sensitivities is larger than 50 dB and the maximum value of “a maximum sensitivity—a minimum sensitivity” is smaller than 35 dB.

As shown in Table 1, the minimum value of average sensitivities is 54.6 dB, which sufficiently satisfies with the required criteria. The maximum value of the difference between the maximum sensitivity and the minimum sensitivity (max−min) in an entire azimuth is 20.9 dB as shown in Table 1. It is appreciated that a good directivity is obtained.

### EMBODIMENT 2

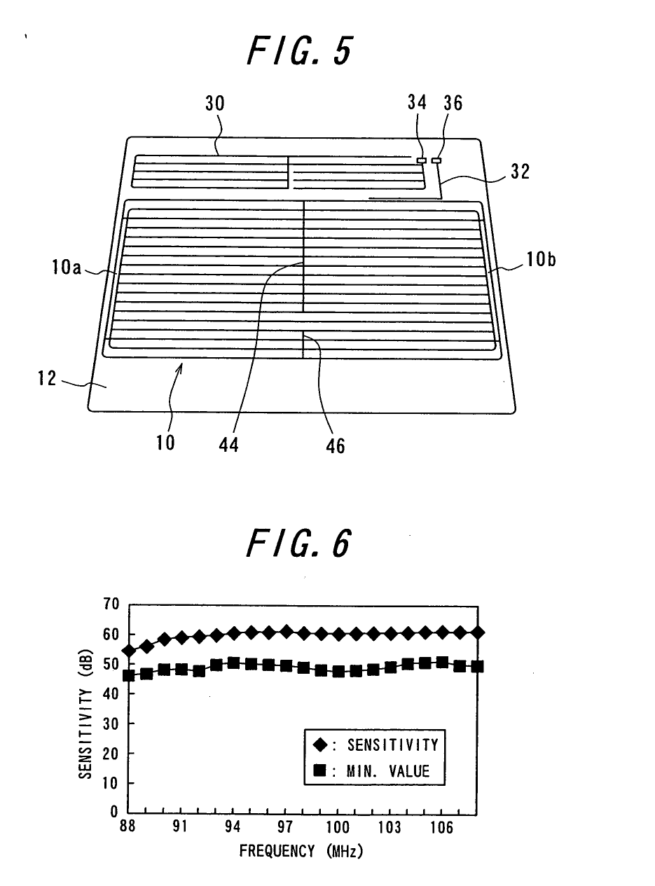

A heating line pattern of the defogger according to the present embodiment is shown in FIG. 5. The heating line pattern according to the present embodiment is the same as that shown in FIG. 2 other than the length of the vertical linear conductor. That is, the vertical linear conductor 44 is longer than the vertical linear conductor 40 in FIG. 2, and the vertical linear conductor 46 is shorter than the vertical linear conductor 42 in FIG. 2. The conductor 44 extends across 12 heating line intervals and the conductor 46 extends across 3 heating line intervals. It is the same as in FIG. 2 that the conductor 44 and conductor 46 are separated across 2 intervals.

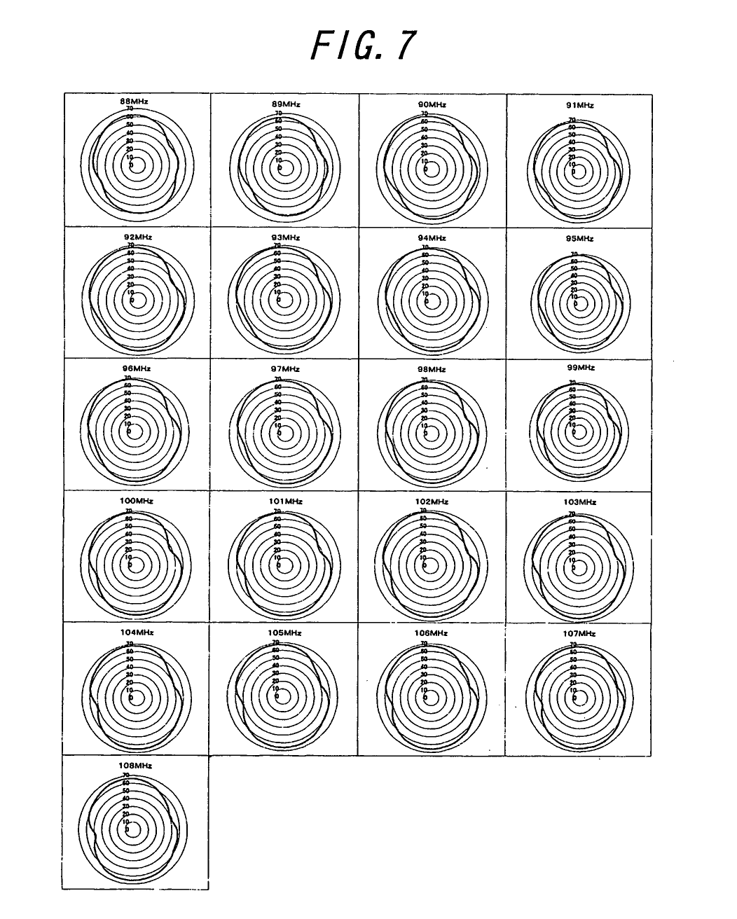

The measured sensitivities of the antenna in FIG. 5 are shown in Table 2. FIG. 6 shows the graph illustrating the minimum values of the measured sensitivities. FIG. 7 shows the measured directivities in the range of 88-108 MHz. Upward direction in the figure designates the forward direction of a motor vehicle.

TABLE 2

Sensitivity (dB)

| f (MHz) | max. | ave. | min. | max. − min. |
|---|---|---|---|---|
| 88 | 62.7 | 55.6 | 46.7 | 16.0 |
| 89 | 65.4 | 57.5 | 47.5 | 17.9 |
| 90 | 67.4 | 59.5 | 49.0 | 18.4 |
| 91 | 67.9 | 60.1 | 48.4 | 19.5 |
| 92 | 67.8 | 60.1 | 47.9 | 19.9 |
| 93 | 68.3 | 60.4 | 49.7 | 18.6 |
| 94 | 69.2 | 61.0 | 50.5 | 18.7 |
| 95 | 69.2 | 61.1 | 50.1 | 19.1 |
| 96 | 68.9 | 60.9 | 49.6 | 19.3 |
| 97 | 68.8 | 60.7 | 49.1 | 19.7 |
| 98 | 68.7 | 60.5 | 48.4 | 20.3 |
| 99 | 68.5 | 60.3 | 47.6 | 20.9 |
| 100 | 68.6 | 60.3 | 47.4 | 21.2 |
| 101 | 68.6 | 60.5 | 47.8 | 20.8 |
| 102 | 68.5 | 60.6 | 48.3 | 20.2 |
| 103 | 68.2 | 60.7 | 49.2 | 19.0 |
| 104 | 68.1 | 60.9 | 49.9 | 18.2 |
| 105 | 67.9 | 61.0 | 50.5 | 17.4 |
| 106 | 67.6 | 60.9 | 50.7 | 16.9 |
| 107 | 67.1 | 60.7 | 49.6 | 17.5 |
| 108 | 66.2 | 60.0 | 48.0 | 18.2 |
| max. | | | | 21.2 |
| ave. | | 60.2 | | |
| min. | | 55.6 | 46.7 | |

| | |
|---|---|
| ave. sensitivity min. | 55.6 |
| directivity min. | 46.7 |
| directivity (max. − min.) max. | 21.2 |

As shown in Table 2, the minimum value of average sensitivities is 55.6 dB, which sufficiently satisfies with the required criteria. The maximum value of the difference between the maximum sensitivity and the minimum sensitivity (max−min) in an entire azimuth is 21.2 dB as shown in Table 2. It is appreciated that a good directivity is obtained.

### EMBODIMENT 3

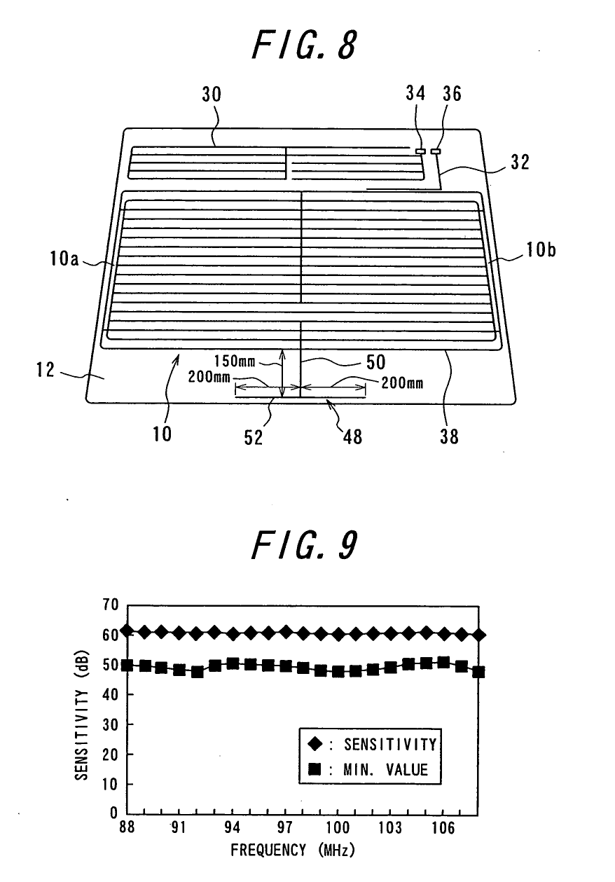

A heating line pattern of the defogger according to the present embodiment is shown in FIG. 8. The heating line pattern of this embodiment is that where a T-shaped conductor 48 is added in a space under the defogger 40 in FIG. 5. The T-shaped conductor 48 is upside down in the figure and is composed of a vertical linear conductor 50 of 150 mm and a horizontal linear conductor 52 of 400 mm, the top end of the conductor 50 being connected the bottommost heating line 38.

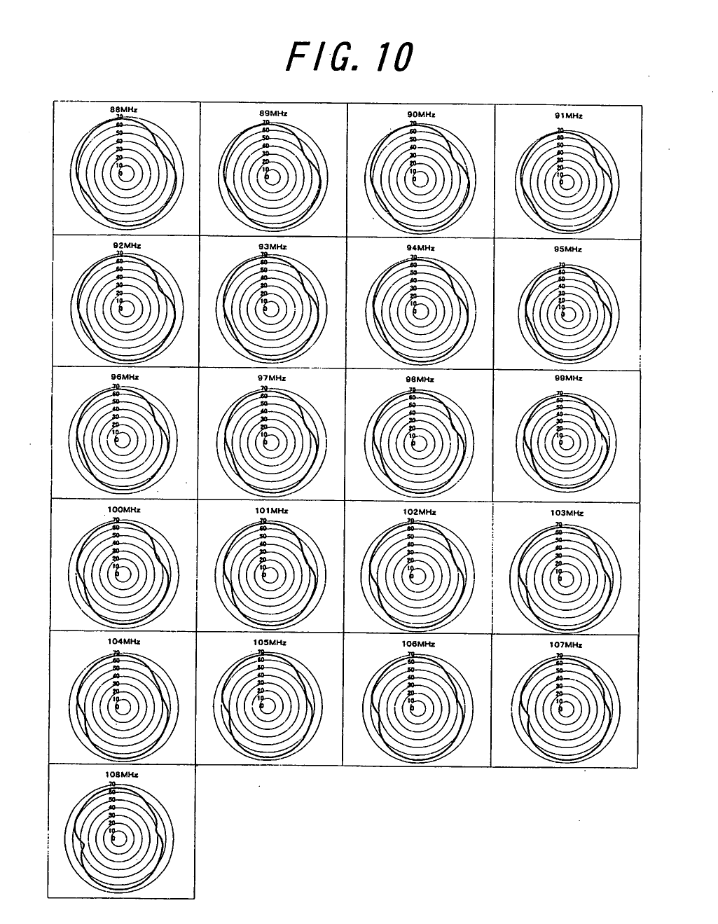

The measured sensitivities of the antenna in FIG. 8 are shown in Table 3. FIG. 9 shows the graph illustrating the minimum values of sensitivities. FIG. 10 shows the measured directivities in the range of 88-108 MHz. Upward direction in the figure designates the forward direction of a motor vehicle.

TABLE 3

Sensitivity (dB)

| f (MHz) | max. | ave. | min. | max. − min. |
|---|---|---|---|---|
| 88 | 68.4 | 61.6 | 50.3 | 18.1 |
| 89 | 68.6 | 61.8 | 49.7 | 18.9 |
| 90 | 68.7 | 62.0 | 49.1 | 19.6 |
| 91 | 68.2 | 61.7 | 48.6 | 19.6 |
| 92 | 67.7 | 61.3 | 47.2 | 20.5 |
| 93 | 67.7 | 61.2 | 49.2 | 18.5 |
| 94 | 67.7 | 61.0 | 49.7 | 18.0 |
| 95 | 67.4 | 60.6 | 49.2 | 18.2 |
| 96 | 67.1 | 60.2 | 49.0 | 18.1 |
| 97 | 67.1 | 60.0 | 48.7 | 18.4 |
| 98 | 67.2 | 59.9 | 48.2 | 19.0 |
| 99 | 67.2 | 59.8 | 47.7 | 19.5 |
| 100 | 67.4 | 59.9 | 47.8 | 19.6 |
| 101 | 67.5 | 60.1 | 48.3 | 19.2 |
| 102 | 67.4 | 60.2 | 48.9 | 18.5 |
| 103 | 67.2 | 60.4 | 49.7 | 17.5 |
| 104 | 67.2 | 60.6 | 50.5 | 16.7 |
| 105 | 67.1 | 60.8 | 50.7 | 16.4 |
| 106 | 66.8 | 60.7 | 50.1 | 16.7 |
| 107 | 66.4 | 60.4 | 49.0 | 17.4 |
| 108 | 65.7 | 59.7 | 46.1 | 19.6 |
| max. | | | | 20.5 |
| ave. | | 60.7 | | |
| min. | | 59.7 | 46.1 | |

| | |
|---|---|
| ave. sensitivity min. | 59.7 |
| directivity min. | 46.1 |
| directivity (max. − min.) max. | 20.5 |

As shown in Table 3, the minimum value of average sensitivities is 59.7 dB, which sufficiently satisfies with the required criteria. The maximum value of the difference between the maximum sensitivity and the minimum sensitivity (max−min) in an entire azimuth is 20.5 dB as shown in Table 3. It is appreciated that a good directivity is obtained.

### EMBODIMENT 4

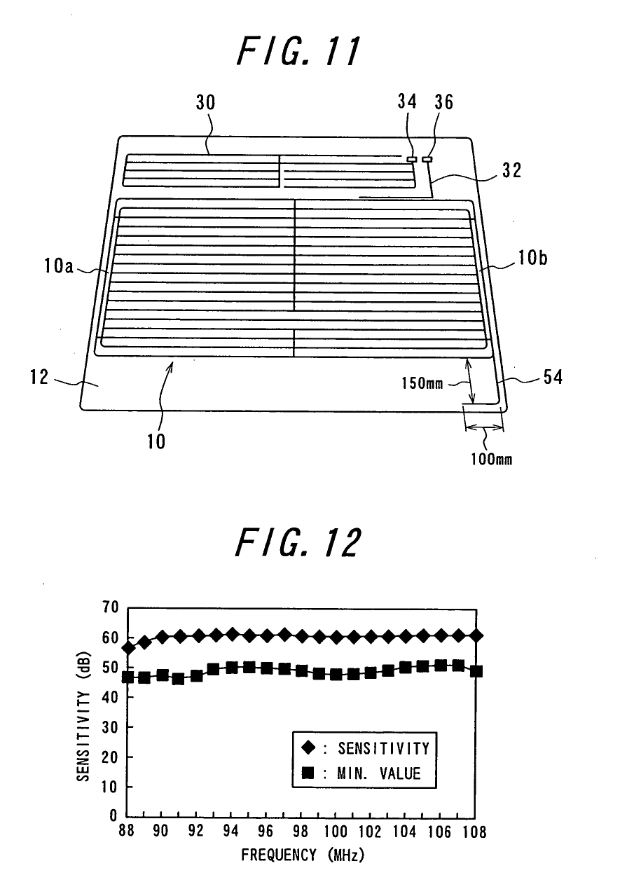

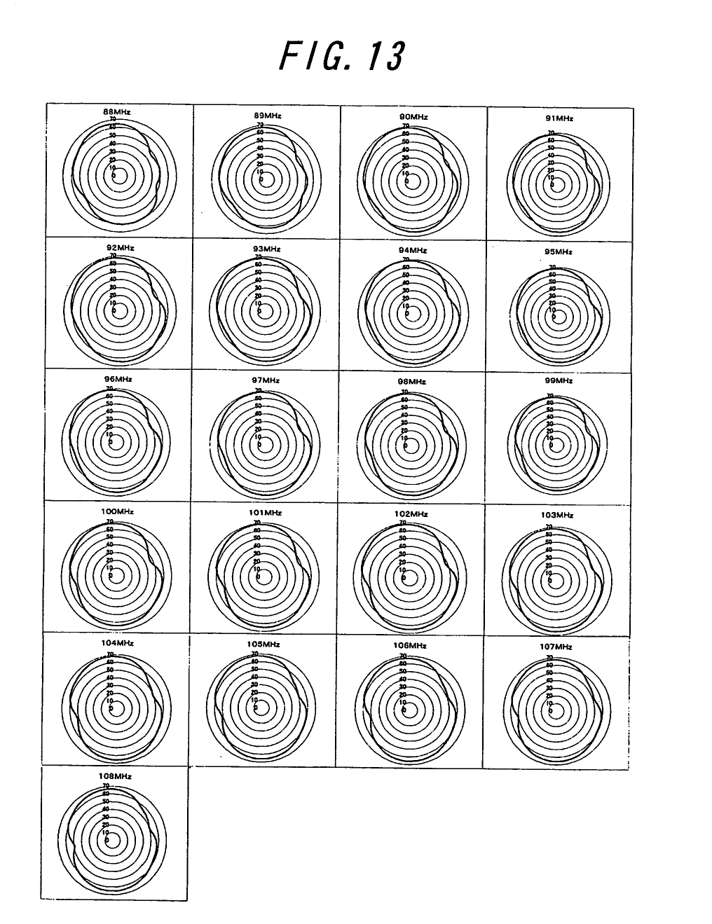

A heating line pattern of the defogger according to the present embodiment is shown in FIG. 11. The heating line pattern of this embodiment is that where a bent conductor 54 is added in a space under the defogger 40 in FIG. 5, the bent conductor being connected to the bus-bar 10b. The bent conductor 54 is composed of a vertical linear conductor of 150 mm and a horizontal linear conductor of 100 mm. The measured sensitivities of the antenna in FIG. 11 are shown in Table 4. FIG. 12 shows the graph illustrating the minimum values of sensitivities. FIG. 13 shows the measured directivities in the range of 88-108 MHz. Upward direction in the figure designates the forward direction of a motor vehicle.

TABLE 4

Sensitivity (dB)

| f (MHz) | max. | ave. | min. | max. − min. |
|---|---|---|---|---|
| 88 | 65.1 | 56.7 | 46.5 | 18.6 |
| 89 | 67.3 | 58.6 | 46.1 | 21.2 |
| 90 | 68.5 | 60.3 | 47.3 | 21.2 |
| 91 | 68.4 | 60.4 | 46.1 | 22.3 |
| 92 | 68.2 | 60.5 | 46.9 | 21.3 |
| 93 | 68.7 | 60.9 | 48.9 | 19.8 |
| 94 | 69.3 | 61.3 | 49.4 | 19.9 |
| 95 | 69.1 | 61.1 | 48.8 | 20.3 |
| 96 | 68.8 | 60.8 | 48.3 | 20.5 |
| 97 | 68.8 | 60.6 | 47.9 | 20.7 |
| 98 | 68.6 | 60.5 | 47.2 | 21.4 |
| 99 | 68.4 | 60.2 | 46.6 | 21.8 |
| 100 | 68.5 | 60.3 | 46.7 | 21.8 |
| 101 | 68.5 | 60.5 | 47.0 | 21.5 |
| 102 | 68.4 | 60.6 | 47.7 | 20.7 |
| 103 | 68.1 | 60.7 | 48.6 | 19.5 |
| 104 | 68.1 | 60.9 | 49.6 | 18.5 |
| 105 | 67.9 | 61.0 | 50.5 | 17.4 |
| 106 | 67.6 | 60.9 | 51.2 | 16.4 |
| 107 | 67.2 | 60.7 | 50.7 | 16.5 |
| 108 | 66.5 | 60.0 | 48.9 | 17.6 |
| max. | | | | 22.3 |
| ave. | | 60.4 | | |
| min. | | 56.7 | 46.1 | |

| | |
|---|---|
| ave. sensitivity min. | 56.7 |
| directivity min. | 46.1 |
| directivity (max. − min.) max. | 22.3 |

As shown in Table 4, the minimum value of average sensitivities is 56.7 4B, which sufficiently satisfies with the required criteria. The maximum value of the difference between the maximum sensitivity and the minimum sensitivity (max−min) in an entire azimuth is 22.3 dB as shown in Table 4. It is appreciated that a good directivity is obtained.

Next, comparison examples where the required criteria are satisfied with but the directivities are not good will be described.

### COMPARISON EXAMPLE 1

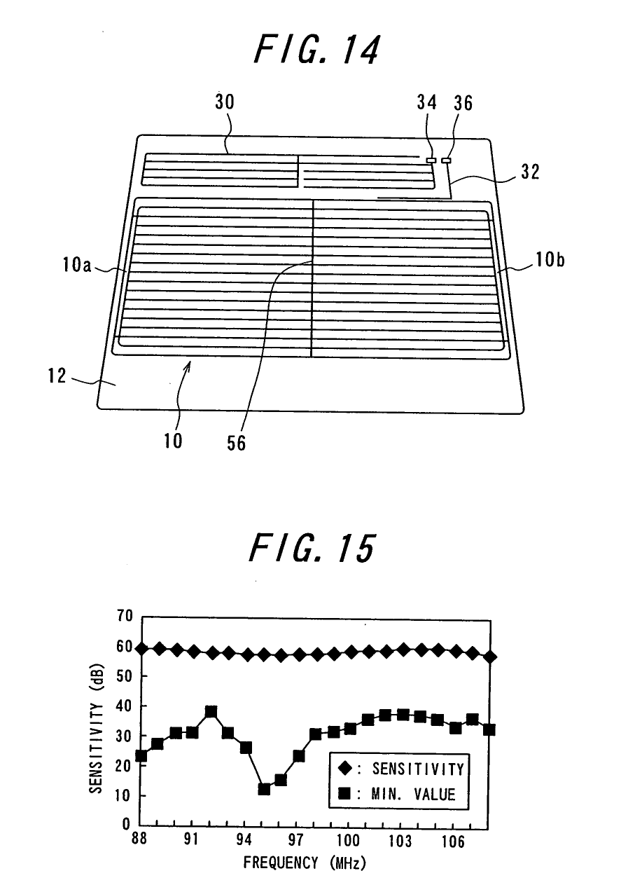

A defogger 10, AM antenna 30, FM antenna 32 are formed on a rear window glass panel 12 of a motor vehicle as shown in FIG. 14. The AM and FM antennas are the same as that in FIG. 2.

Different from the structure of the embodiment 1 shown in FIG. 2, only one vertical linear conductor is formed at the center portion of the defogger. One linear conductor is designated by reference numeral 56.

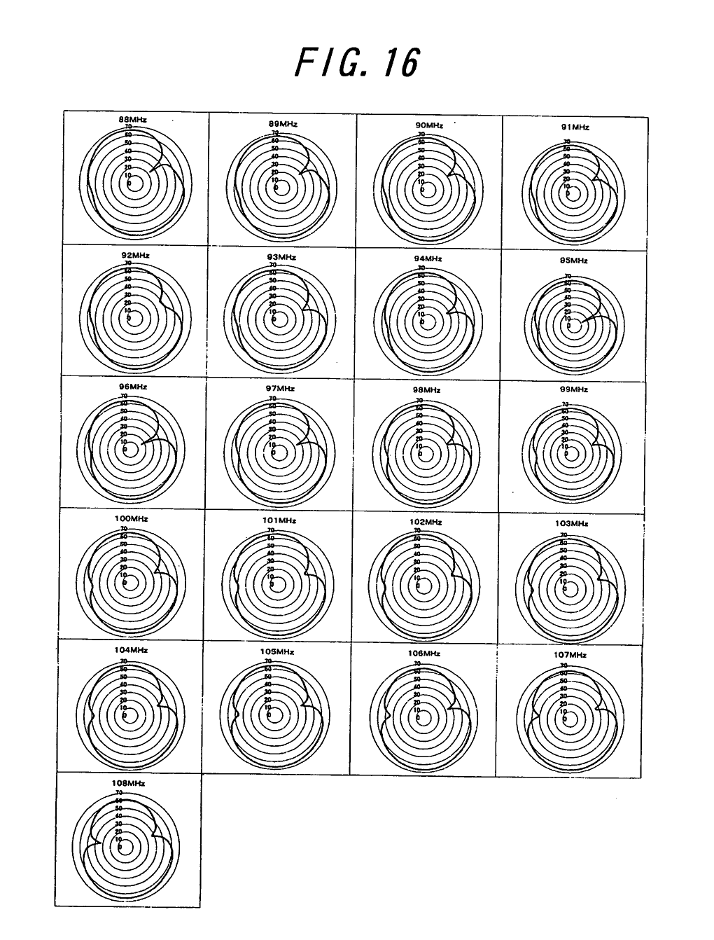

The measured sensitivities of the antenna in FIG. 14 are shown in Table 5. FIG. 15 shows the graph illustrating the minimum values of sensitivities. FIG. 16 shows the measured directivities in the range of 88-108 MHz. Upward direction in the figure designates the forward direction of a motor vehicle.

TABLE 5

Sensitivity (dB)

| f (MHz) | max. | ave. | min. | max. − min. |
|---|---|---|---|---|
| 88 | 67.0 | 60.2 | 23.6 | 43.4 |
| 89 | 66.7 | 60.0 | 27.6 | 39.1 |
| 90 | 66.6 | 59.8 | 31.0 | 35.6 |
| 91 | 66.1 | 59.3 | 31.6 | 34.5 |
| 92 | 65.1 | 58.7 | 38.6 | 26.5 |
| 93 | 64.7 | 58.5 | 31.3 | 33.4 |
| 94 | 64.7 | 58.6 | 26.8 | 37.9 |
| 95 | 64.6 | 58.4 | 12.4 | 52.2 |
| 96 | 64.5 | 58.3 | 15.2 | 49.3 |
| 97 | 64.7 | 58.4 | 23.6 | 41.1 |
| 98 | 65.0 | 58.6 | 30.9 | 34.1 |
| 99 | 65.1 | 58.7 | 32.0 | 33.1 |
| 100 | 65.5 | 59.1 | 32.9 | 32.6 |
| 101 | 65.7 | 59.5 | 35.9 | 29.8 |
| 102 | 65.7 | 59.7 | 37.6 | 28.1 |
| 103 | 66.1 | 59.9 | 37.1 | 29.0 |
| 104 | 66.5 | 60.1 | 36.9 | 29.6 |
| 105 | 66.7 | 60.1 | 35.9 | 30.8 |
| 106 | 66.5 | 59.7 | 33.0 | 33.5 |
| 107 | 66.0 | 59.0 | 35.7 | 30.3 |
| 108 | 65.4 | 57.9 | 32.5 | 32.9 |
| max. | | | | 52.2 |
| ave. | | 59.2 | | |
| min. | | 57.9 | 12.4 | |

| | |
|---|---|
| ave. sensitivity min. | 57.9 |
| directivity min. | 12.4 |
| directivity (max. − min.) max. | 52.2 |

As shown in Table 5, the minimum value of average sensitivities is 57.9 dB, which sufficiently satisfied with the required criteria. The maximum value of the difference between the maximum sensitivity and the minimum sensitivity (max−min) in an entire azimuth is 52.5 dB as shown in Table 5. It is appreciated that there is a steep drop in the sensitivity at a specific azimuth so that a good directivity is not obtained.

### COMPARISON EXAMPLE 2

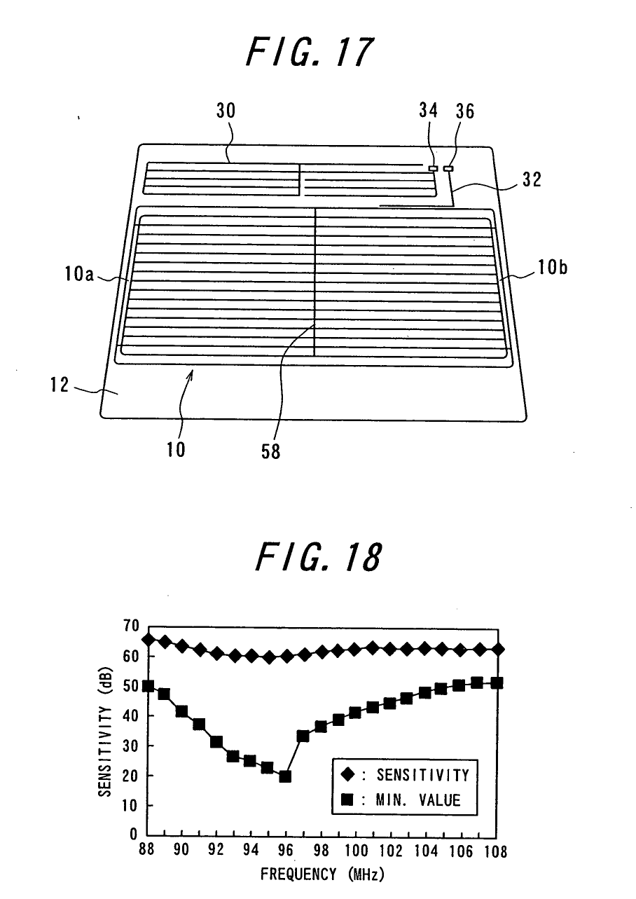

A heating line pattern of the defogger according to the present comparison example is shown in FIG. 17. The heating line pattern includes one vertical linear conductor 58 at the center portion of the defogger. The conductor 58 is shorter than the conductor 56 of the comparison example 1 by one heating line interval.

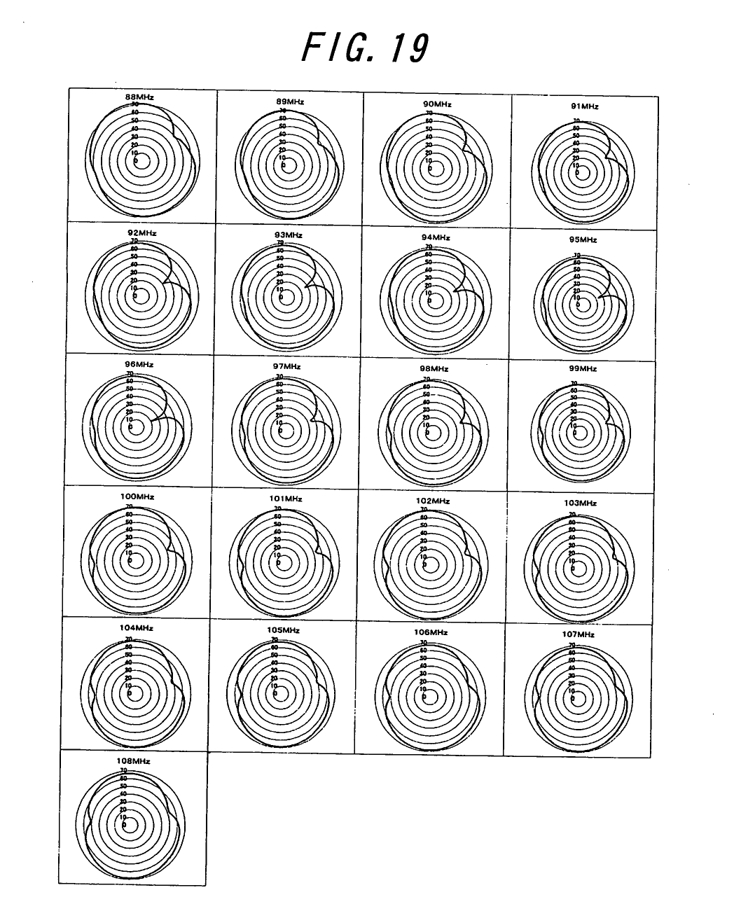

The measured sensitivities of the antenna in FIG. 17 are shown in Table 6. FIG. 18 shows the graph illustrating the minimum values of sensitivities. FIG. 19 shows the measured directivities in the range of 88-108 MHz. Upward direction in the figure designates the forward direction of a motor vehicle.

TABLE 6

Sensitivity (dB)

| f (MHz) | max. | ave. | min. | max. − min. |
|---|---|---|---|---|
| 88 | 72.2 | 65.1 | 49.4 | 22.8 |
| 89 | 71.3 | 64.3 | 47.1 | 24.2 |
| 90 | 70.4 | 63.2 | 41.2 | 29.2 |
| 91 | 69.1 | 61.9 | 37.2 | 31.9 |
| 92 | 67.9 | 60.8 | 31.3 | 36.6 |
| 93 | 67.4 | 60.4 | 26.7 | 40.7 |
| 94 | 67.2 | 60.2 | 25.4 | 41.8 |
| 95 | 67.0 | 60.0 | 23.3 | 43.7 |
| 96 | 67.1 | 60.2 | 20.5 | 46.6 |
| 97 | 67.8 | 61.0 | 33.7 | 34.1 |
| 98 | 68.4 | 61.6 | 36.7 | 31.7 |
| 99 | 68.7 | 62.0 | 39.0 | 29.7 |
| 100 | 69.2 | 62.6 | 41.4 | 27.8 |
| 101 | 69.3 | 62.9 | 42.8 | 26.5 |
| 102 | 68.9 | 62.7 | 44.4 | 24.5 |
| 103 | 68.4 | 62.6 | 46.2 | 22.2 |
| 104 | 68.6 | 62.7 | 47.8 | 20.8 |
| 105 | 68.6 | 62.8 | 49.3 | 19.3 |
| 106 | 68.4 | 62.6 | 50.4 | 18.0 |
| 107 | 68.5 | 62.7 | 51.5 | 17.0 |
| 108 | 68.4 | 62.6 | 51.2 | 17.2 |
| max. | | | | 46.6 |
| ave. | | 62.1 | | |
| min. | | 60.0 | 20.5 | |

| | |
|---|---|
| ave. sensitivity min. | 60.0 |
| directivity min. | 20.5 |
| directivity (max. − min.) max. | 46.6 |

As shown in Table 6, the minimum value of average sensitivities is 60.0 dB, which sufficiently satisfies with the required criteria. The maximum value of the difference between the maximum sensitivity and the minimum sensitivity (max−min) in an entire azimuth is 46.4 dB as shown in Table 5. It is appreciated that there is a steep drop in the sensitivity at a specific azimuth so that a good directivity is not obtained.

While the embodiments of the present invention have been described, the antenna patterns of AM and FM antennas are not limited thereto. It is understood for those skilled in the art that any type of antenna pattern may be utilized.

1. A structure of a heating line pattern of a defogger formed on a rear window glass panel on which AM and FM antennas are provided, the FM antenna being arranged between the AM antenna and the defogger, comprising:
two bus-bars formed on both sides of the rear window glass panel;
a plurality of heating lines arranged in parallel in a horizontal direction between the two bus-bars; and
first and second linear conductors formed in a line in a vertical direction at the central portion of the defogger.

2. The structure of a heating line pattern according to claim 1, wherein
the first linear conductor extends downward from the topmost hearing line of the plurality of heating lines;
the second linear conductor extends upward from the bottommost heating line of the plurality of heating lines; and
the first and second linear conductors are separated across at least one heating line interval, one heating line interval being the distance between adjacent heating lines.

3. The structure of a heating line pattern according to claim 1, wherein the first linear conductor is longer than the second linear conductor.

4. The structure of a heating line pattern according to claim 2 or 3, wherein the second linear conductor extends across at least one heating line interval.

5. The heating line structure according to any one of claims 1-3, wherein a T-shaped conductor composed of a vertical linear conductor and horizontal conductor is formed under the defogger, the vertical linear conductor being connected to a bottommost heating line of the plurality of heating lines.

6. The structure of a heating line pattern according to any one of claims 1-3, wherein a bent conductor is formed under the defogger, the bent conductor being connected to one of the two bus-bars.

7. An antenna for a motor vehicle, comprising:
an AM antenna formed on a rear window glass panel of the motor vehicle;
an FM antenna formed on the rear window glass panel; and
a defogger according to any one of claims 1-3,
wherein the FM antenna is arranged between the AM antenna and the defogger.
